(19) United States
(12) Patent Application Publication
(10) Pub. No.: US 2025/0229550 A1
(43) Pub. Date: Jul. 17, 2025

(54) IMAGE FORMING APPARATUS

(71) Applicant: CANON KABUSHIKI KAISHA, Tokyo (JP)

(72) Inventor: EIKOU MORI, Tokyo (JP)

(21) Appl. No.: 18/999,404

(22) Filed: Dec. 23, 2024

(30) Foreign Application Priority Data
Jan. 12, 2024 (JP) 2024-003561

(51) Int. Cl. B41J 11/00

(52) U.S. Cl. CPC B41J 11/0055; B41J 11/003; B41J 11/0095

(57) ABSTRACT

An image forming apparatus includes a skew feed correcting portion, and a detection unit. A control unit selectively executes a first mode and a second mode by switching between the first mode and the second mode. In the first mode, based on the skew of a leading edge of the sheet and the position of the sheet in the width direction which are detected by the detection unit, the control unit is configured to correct the skew of the sheet to align the leading edge of the sheet with the width direction, correct the position of the sheet in the width direction using a first width direction position as a reference or using a second width direction position as a reference which is different from the first width direction position, and set an image formation position for forming the image with respect to the sheet which has been corrected.

### BACKGROUND OF THE INVENTION

### Field of the Invention

This disclosure relates to an image forming apparatus that forms an image on a sheet.

### Description of the Related Art

Recently, in image forming apparatuses, accuracy of an image formation position with respect to a sheet becomes important. Therefore, a technique that performs image formation position correction by reading a test chart for correcting the image formation position is developed (refer to Japanese Patent Laid-Open No. 2021-092806).

On the other hand, as integrated printing systems including the image forming apparatus, systems that incorporate folding, cutting, and binding machines are being widely used. In this type of the image formation systems, the required image formation position with respect to the sheet varies depending on a method of post processing. For example, in a case of saddle stitch binding, correction to position the image at the center of the sheet both in a sheet conveyance direction and width direction of the sheet is required. In addition, in a case of case binding, since the sheet is cut using edges as a reference, correction to position the image using the sheet edges in both the sheet conveyance direction and width direction as a reference is required. Therefore, for the correction of the image formation position, techniques that also consider post processing steps are required. Therefore, a technique to switch the image formation position in the sheet conveyance direction, in which the sheet is printed, depending on the post processing steps and the like is developed (refer to Japanese Patent Laid-Open No. 2019-184944).

As described above, in the image forming apparatuses, the accuracy of the image formation position is important, and, by considering sheet characteristics, including cutting accuracy and deformation, as disturbances, it is necessary to improve the accuracy of the image formation position in both cases of whether the post processing is performed or not.

However, in the image forming apparatus described in the aforementioned Japanese Patent Laid-Open No. 2021-092806 and No. 2019-184944, the skew of the sheet is not considered. That is, as sheet cutting errors, it is necessary to consider not only errors in the conveyance and width directions but also errors in skew components. The errors in the skew components of the sheet cause the print position with respect to the sheet to vary depending on whether the skew of the sheet is corrected using a leading edge of the sheet as a reference or using a left edge of the sheet as a reference. Therefore, when the skew components of the sheet are not considered, there is a risk that the accuracy of the image formation position may decline.

The purpose of this disclosure is to provide an image forming apparatus that can improve the accuracy of the image formation position even in a case where the skew occurs in the sheet.

### SUMMARY OF THE INVENTION

According to a first aspect of the present invention, an image forming apparatus includes an image forming unit configured to form an image on a sheet, a conveyance unit configured to convey the sheet in a conveyance path, a skew feed correcting portion configured to correct skew of the sheet conveyed by the conveyance unit and a position of the sheet in a width direction perpendicular to a sheet conveyance direction, a detection unit configured to detect the sheet before the sheet conveyed by the conveyance unit has passed through the skew feed correcting portion, and a control unit configured to control the skew feed correcting portion and the image forming unit. The control unit is configured to selectively execute a first mode and a second mode by switching between the first mode and the second mode. In the first mode, based on skew of a leading edge of the sheet and the position of the sheet in the width direction which are detected by the detection unit, the control unit is configured to correct the skew of the sheet to align the leading edge of the sheet with the width direction, correct the position of the sheet in the width direction using a first width direction position as a reference, using a second width direction position as a reference which is different from the first width direction position in the width direction, or using a third width direction position as a reference which is different from the first width direction position and the second width direction position in the width direction, and set an image formation position for forming the image with respect to the sheet which has been corrected. In the second mode, based on skew of a side edge of the sheet and the position of the sheet in the width direction which are detected by the detection unit, the control unit is configured to correct the skew of the sheet to align the side edge of the sheet with the sheet conveyance direction, correct the position of the sheet in the width direction using the first width direction position as the reference, using the second width direction position as the reference, or using the third width direction position as the reference, and set the image formation position with respect to the sheet which has been corrected.

According to a second aspect of the present invention, an image forming apparatus includes an image forming unit configured to form an image on a sheet, a conveyance unit configured to convey the sheet in a conveyance path, a skew feed correcting portion configured to correct skew of the sheet conveyed by the conveyance unit and a position of the sheet in a width direction perpendicular to a sheet conveyance direction, a detection unit configured to detect the sheet before the sheet conveyed by the conveyance unit has passed through the skew feed correcting portion, and a control unit configured to control the skew feed correcting portion and the image forming unit. The control unit is configured to selectively execute a first mode and a second mode by switching between the first mode and the second mode. In the first mode, based on the skew of a leading edge of the sheet and the position of the sheet in the width direction which are detected by the detection unit, the control unit is configured to correct the skew of the sheet to align the leading edge of the sheet with the width direction, correct the position of the sheet in the width direction using a first width direction position as a reference or using a second width direction position as a reference which is different from the first width direction position, and set an image formation position for forming the image with respect to the sheet which has been corrected. In the second mode, based on skew of a side edge of the sheet and the position of the sheet in the width direction which are detected by the detection unit, the control unit is configured to correct the skew of the sheet to align the side edge of the sheet with the sheet conveyance direction, correct the position of the sheet in the width direction using the first width direction position as the reference or using the second width direction position as the reference, and set the image formation position with respect to the sheet which has been corrected.

Further features of the present invention will become apparent from the following description of exemplary embodiments with reference to the attached drawings.

### BRIEF DESCRIPTION OF THE DRAWINGS

FIG. 1 is a cross-sectional view illustrating an image forming system according to an embodiment.

FIG. 2 is a cross-sectional view illustrating a recording unit and a print belt unit of a print module according to the embodiment.

FIG. 3 is a perspective view illustrating the print belt unit of the print module according to the embodiment.

FIG. 4 is a plan view illustrating a registration unit of the print module according to the embodiment.

FIG. 5 is a perspective view illustrating the registration unit of the print module according to the embodiment.

FIG. 6 is a cross-sectional view illustrating the registration unit of the print module according to the embodiment.

FIG. 7A is a plan view illustrating operations of rollers in the registration unit according to the embodiment, and illustrated is an operation of conveying a sheet linearly along a sheet conveyance direction.

FIG. 7B is a plan view illustrating the operations of the rollers in the registration unit according to the embodiment, and illustrated is an operation of correcting the skew of the sheet.

FIG. 7C is a plan view illustrating the operations of the rollers in the registration unit according to the embodiment, and illustrated is an operation of correcting a lateral position of the sheet.

FIG. 8 is a block diagram illustrating a control system in the print module according to the embodiment.

FIG. 9 is a cross-sectional view illustrating an inline scanner unit of the print module according to the embodiment.

FIG. 10 is a plan view illustrating a test chart indicating coordinates for a sheet shape and patch positions according to the embodiment.

FIG. 11A is an explanatory diagram illustrating a case of performing the correction for leading registration according to the embodiment, and illustrated is a state before the correction.

FIG. 11B is an explanatory diagram illustrating a case of performing the correction for the leading registration according to the embodiment, and illustrated is a state after the correction using a leading edge of the sheet as a reference.

FIG. 11C is an explanatory diagram illustrating a case of performing the correction for the leading registration according to the embodiment, and illustrated is a state after the correction using the center of the sheet as a reference.

FIG. 12A is an explanatory diagram illustrating a case of performing the correction for lateral registration according to the embodiment, and illustrated is a state before the correction.

FIG. 12B is an explanatory diagram illustrating a case of performing the correction for the lateral registration according to the embodiment, and illustrated is a state after the correction using a side edge of the sheet as a reference.

FIG. 12C is an explanatory diagram illustrating a case of performing the correction for the lateral registration according to the embodiment, and illustrated is a state after the correction using the center of the sheet as a reference.

FIG. 13A is an explanatory diagram illustrating a case of performing skew correction on a long sheet without involving post processing, and illustrated is a case of the correction using the leading edge of the sheet as a reference.

FIG. 13B is an explanatory diagram illustrating a case of performing the skew correction on the long sheet without involving the post processing, and illustrated is a case of the correction using the left edge of the sheet as a reference.

FIG. 14A is an explanatory diagram illustrating an image formation position in a case of performing the skew correction on the sheet that is cut on three sides during the post processing, and illustrated is a case where the skew correction is performed using the left edge of the sheet as a reference.

FIG. 14B is an explanatory diagram illustrating an image formation position in the case of performing the skew correction on the sheet that is cut on three sides during the post processing, and illustrated is a case where the skew correction is performed using the leading edge of the sheet as reference.

FIG. 15A is an explanatory diagram illustrating the image formation position in a case of performing the skew correction according to the embodiment, and illustrated is a state before the correction.

FIG. 15B is an explanatory diagram illustrating the image formation position in the case of performing the skew correction according to the embodiment, and illustrated is a case where the skew correction is performed using the left edge of the sheet as a reference.

FIG. 15C is an explanatory diagram illustrating the image formation position in the case of performing the skew correction according to the embodiment, and illustrated is a case where the skew correction is performed using the leading edge of the sheet as a reference.

FIG. 16 is a flowchart illustrating processing steps in a case of executing image formation by the image forming system according to the embodiment.

FIG. 17 is a diagram illustrating a media library screen displayed on an operation unit according to the embodiment.

FIG. 18 is a diagram illustrating a print position adjustment screen displayed on the operation unit according to the embodiment.

FIG. 19 is a diagram illustrating a selection screen for selecting a correction reference for a print position adjustment displayed on the operation unit according to the embodiment.

FIG. 20A is an explanatory diagram illustrating a case of performing the skew correction according to the embodiment, and illustrated is a case where the skew correction is performed on the long sheet without involving the post processing using the left edge of the sheet as a reference.

FIG. 20B is an explanatory diagram illustrating a case of performing the skew correction according to the embodiment, and illustrated is a case where the skew correction is performed on the sheet, which is cut on the three sides during the post processing, using the leading edge of the sheet as a reference.

### DESCRIPTION OF THE EMBODIMENTS

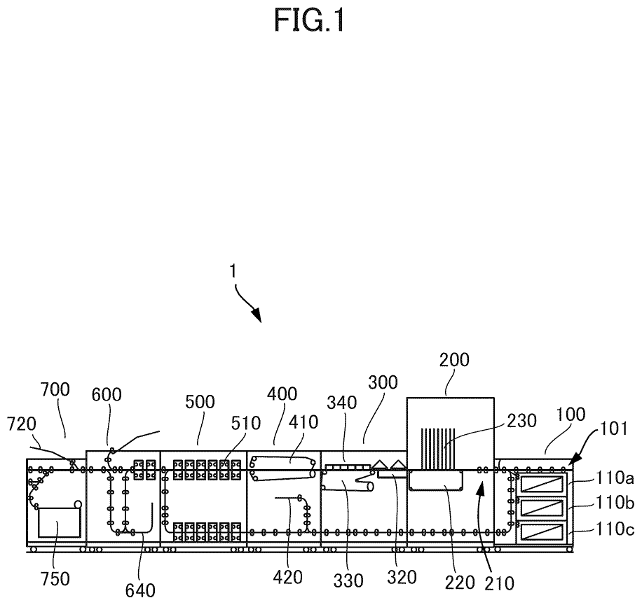

Hereinafter, using drawings, the present embodiment will be described. In the present embodiment, a case where an image forming system is applied to an inkjet recording system 1 will be described. FIG. 1 is a schematic diagram illustrating an example of a schematic configuration of the inkjet recording system 1. This inkjet recording system 1 is a sheet-fed type inkjet recording system that produces a recording matter that forms an ink image on a sheet S using two liquids of reaction liquid and ink. As illustrated in FIG. 1, the inkjet recording system 1 is constituted from a feed module 100, a print module 200, a drying module 300, a fixing module 400, a cooling module 500, a reverse module 600, and a sheet discharge module 700. The sheet S, in a shape of cut paper, supplied from the feed module 100 is conveyed along a sheet conveyance path, and, after having been processed in each module, is discharged at the sheet discharge module 700. In the present embodiment, the drying module 300, the fixing module 400, the cooling module 500, the reverse module 600, and the sheet discharge module 700 are examples of a sheet processing apparatus that performs processing with respect to the sheet on which the image has been formed by the print module 200.

The feed module 100 includes three storage compartments 110a, 110b, and 110c that store the sheet S. Each of the storage compartments 110a, 110b, and 110c is drawable toward the front side of the apparatus. In each of the storage compartments 110a, 110b, and 110c, the sheet S is fed by a separation belt and a conveyance roller, not shown, one sheet at a time, and is conveyed to the print module 200. To be noted, the number of the storage compartments is not limited to three, and the feed module 100 may include one or two, or equal to or more than four storage compartments.

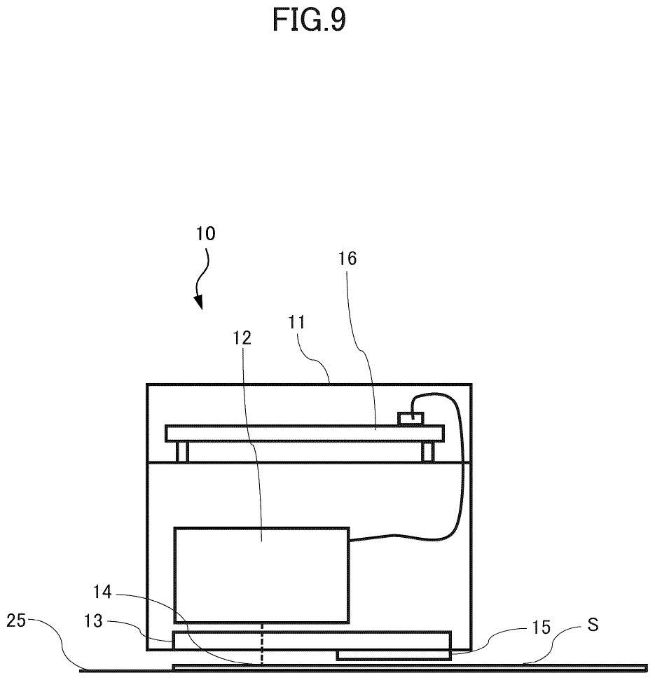

The print module 200, which is an example of an image forming unit, includes a registration unit 210, serving as a registration unit before image formation, a print belt unit 220, a recording unit 230, and a control unit 60 (refer to FIG. 9). An inclination and position of the sheet S conveyed from the feed module 100 is corrected by the registration unit 210, and the sheet S is conveyed to the print belt unit 220. With respect to the sheet conveyance path, the recording unit 230 is arranged at a position facing the print belt unit 220. The recording unit 230 is an example of the image forming unit that performs recording processing (printing) on the conveyed sheet S by recording heads 231 from above. In addition, while, in the present embodiment, the print module 200 includes the control unit 60, it is not limited to this, and it is acceptable if one of the modules within the inkjet recording system 1 includes the control unit 60. Alternatively, an external computer may be applied as the control unit.

The drying module 300 includes a decoupling unit 320, a drying belt unit 330, and a warm air blowing unit 340, and improves the fixability of the ink to the sheet by reducing a liquid content in the ink applied onto the sheet S in the recording unit 230 of the print module 200. The sheet S that has been printed in the recording unit 230 of the print module 200 is conveyed to the decoupling unit 320 located on an upstream side of the drying module 300 in a sheet conveyance direction. In the decoupling unit 320, the sheet S can be conveyed through the pressure of airflow from above and the friction of a belt, and, by gently securing the sheet S on the belt during the conveyance, a positional shift of the sheet S on the print belt unit 220 on which the ink image is formed is prevented. The drying belt unit 330 and the warm air blowing unit 340 are respectively arranged below and above the belt to face each other across the belt. The sheet S that has been conveyed from the decoupling unit 320 is adsorptively conveyed on the drying belt unit 330, and, at the same time, an ink application surface of the sheet S is dried by receiving hot air from the warm air blowing unit 340. To be noted, as a method of drying, instead of applying the hot air, it is acceptable to utilize combined methods that involve the irradiation of the surface of the sheet S with electromagnetic waves (such as ultraviolet and infrared rays) or conductive heat transfer through contact with a heating body.

The fixing module 400 includes a fixing belt unit 410. The fixing belt unit 410 includes an upper belt unit and a lower belt unit, and can fix the ink on the sheet S by passing the sheet S conveyed from the drying module 300 through a gap between the heated upper belt unit and the lower belt unit.

The cooling module 500 includes a plurality of cooling units 510, and cools a high temperature sheet S conveyed from the fixing module 400. By drawing the outside air into cooling boxes with fans to increase the internal pressure of the cooling boxes, the cooling units 510 cool the sheet S by directing the air through nozzles formed in a conveyance guide onto the sheet S. The cooling units 510 are arranged on both upper and lower sides with respect to the sheet conveyance path, and cool the sheet S from both sides.

In addition, the cooling module 500 includes a conveyance path switching portion, and can switch the sheet conveyance path of the sheet S depending on whether the sheet is conveyed to the reverse module 600 or to a duplex conveyance path used during duplex printing. During the duplex printing, the sheet S is conveyed to the sheet conveyance path located in a lower section of the cooling module 500. In this case, the sheet S is further conveyed from the cooling module 500 along duplex conveyance paths of the fixing, drying, print, and feed modules 400, 300, 200, and 100. A first reverse portion 420 that reverses the front and back surfaces of the sheet S is disposed in the duplex conveyance path of the fixing module 400. Then, again, the sheet S is conveyed from the feed module 100 to the registration unit 210, the print belt unit 220, and the recording unit 230 of the print module 200, and is printed in the recording unit 230.

The reverse module 600 includes a second reverse portion 640, and, by reversing the front and back surfaces of the conveyed sheet S, can reverse the front and back surfaces of the sheet S that is discharged. The sheet discharge module 700 includes a top tray 720 and a supporting portion 750, and aligns and stacks the sheet S conveyed from the reverse module 600.

### Print Module

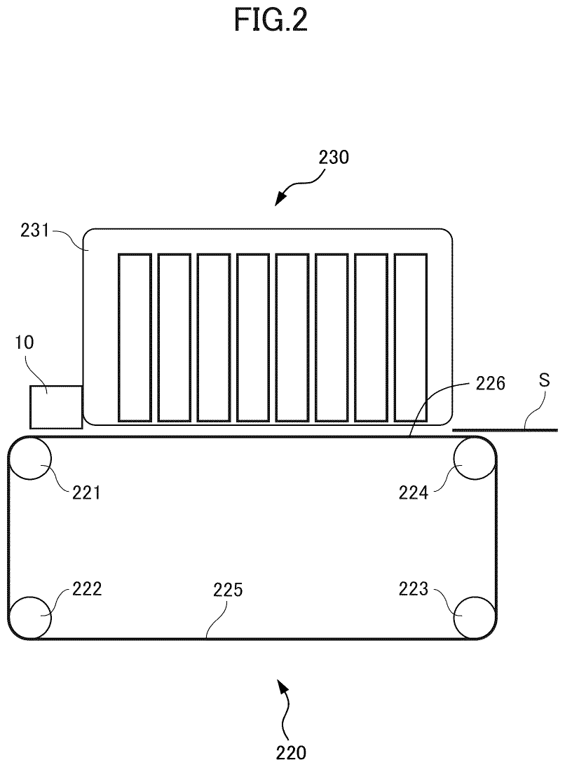

Next, a configuration of the print module 200 will be described. FIG. 2 is a cross-sectional view illustrating the print belt unit 220 and the recording unit 230 of the print module 200. In the print module 200, the image is formed on the sheet by performing the recording processing with respect to the conveyed sheet S from above using the recording heads 231. The print belt unit 220 is positioned directly below the recording unit 230, and utilizes suction adsorption to convey the sheet such that sheet conveyance behavior directly under the recording head 231 is stabilized.

In the present embodiment, in the print belt unit 220, a print belt 225 is stretched by four tension rollers 221, 222, 223, and 224. An outer surface of the print belt 225, which is stretched by the tension rollers 221 and 224 directly under the recording heads 231, of the print belt unit 220 forms an image forming surface 226 on which the image formation is performed. Suction holes, not shown, for suctioning the sheet S are formed in the print belt 225, and, on the image forming surface 226, the print belt 225 conveys the sheet S while suction adsorbing the sheet toward an inner circumferential surface side of the print belt 225. By suction conveying the sheet S by the print belt 225, the sheet S positioned on the image forming surface 226 is conveyed in a state of securing a clearance with the recording heads 231.

The plurality of recording heads 231 are arranged along the conveyance direction. In the present embodiment, eight line-type recording heads corresponding to, in addition to four colors of yellow (Y), magenta (M), cyan (C), and black (K), a reaction liquid and three specialty colors are applied (refer to FIG. 2). To be noted, the variety of the colors and the number of the recording heads are not respectively limited to seven and eight, and, for example, without providing the three specialty colors, five line-type recording heads may be applied. To an inkjet method, methods using such as a heating element, a piezoelectric element, an electrostatic element, and a micro electromechanical system (MEMS) element can be adopted. The ink of each color is supplied from an ink tank, not shown, to each of the recording heads through an ink tube. The sheet S that has been printed in the recording unit 230 is detected for the misalignment and the color density of the image formed on the sheet S by an inline scanner unit 10 located on a downstream side of the recording unit 230 in the sheet conveyance direction. Detection results are utilized for the correction of the printed image. That is, the inline scanner unit 10 is an example of a reading unit, and reads a leading edge and a side edge of the sheet, and the image formed on the sheet at a position further downstream than the recording unit 230.

### Print Belt Unit

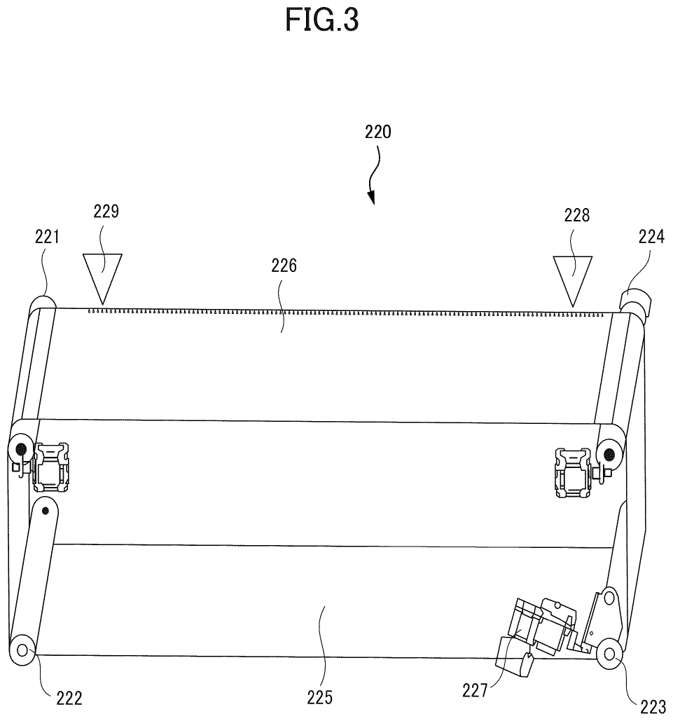

Next, using FIG. 3, the control of the print belt unit 220 in a width direction of the belt in the present embodiment will be described. The width direction of the belt is the same as a width direction of the sheet, and the width direction of the sheet is perpendicular to the sheet conveyance direction in the print belt 225. FIG. 3 is a schematic perspective view illustrating the print belt unit 220.

In the present embodiment, in the print belt unit 220, the tension roller 221 is a drive roller rotatably driving the print belt 225, and is a roller that is movable in an axial direction of the roller. In addition, the tension roller 222 is a tension roller that exerts a force from an inner circumferential side toward an outer circumferential side of the belt for stretching the print belt 225. The tension roller 223 is a steering roller that can tilt the roller by moving one end of a shaft of the roller for reducing the meanderings of the print belt 225. The tension roller 223 that is the steering roller is actuated by a driving source 227. The tension roller 224 is a driven roller that is driven by the rotation of the print belt 225, and is movable in an axial direction of the roller.

An upstream sensor 228 and a downstream sensor 229, which read a position detection configuration located at an edge of the print belt 225, are respectively positioned adjacent to the tension rollers 221 and 224 that can move in the axial direction. Since the sheet S is adsorbed onto the image forming surface 226, by accurately positioning the image forming surface 226, the accuracy of the image can be also improved. Therefore, rollers capable of moving in the roller axial direction to adjust the position of the print belt 225 are desirably the two tension rollers 221 and 224 that form the image forming surface 226.

The upstream and downstream sensors 228 and 229 are respectively disposed adjacent to the tension rollers 221 and 224. The tension roller 221 moves the roller in the axial direction of the roller based on the belt position detection result of the downstream sensor 229, and adjusts the position of the print belt 225. The tension roller 224 moves the roller in the axial direction of the roller based on the belt position detection result of the upstream sensor 228, and adjusts the position of the print belt 225. By adjusting the position of the print belt 225 using the tension rollers 221 and 224 that form the image forming surface 226, the entire image forming surface 226 can be precisely positioned.

### Registration Unit

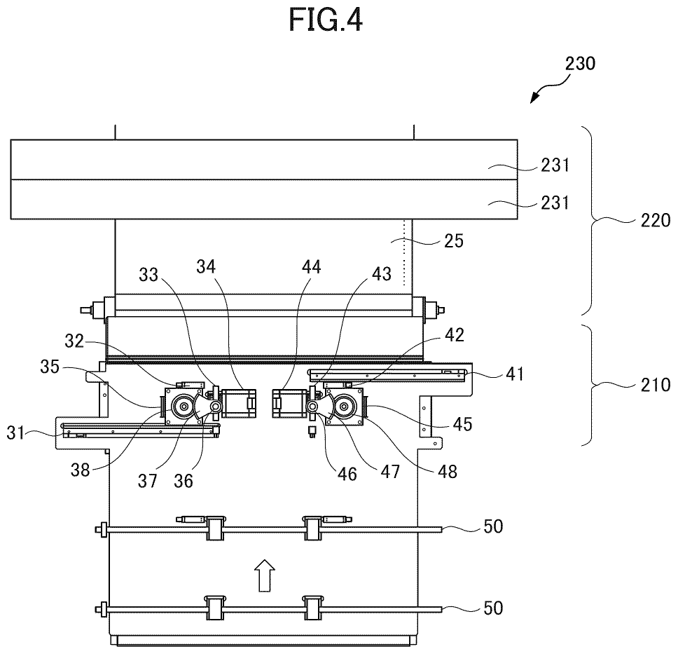

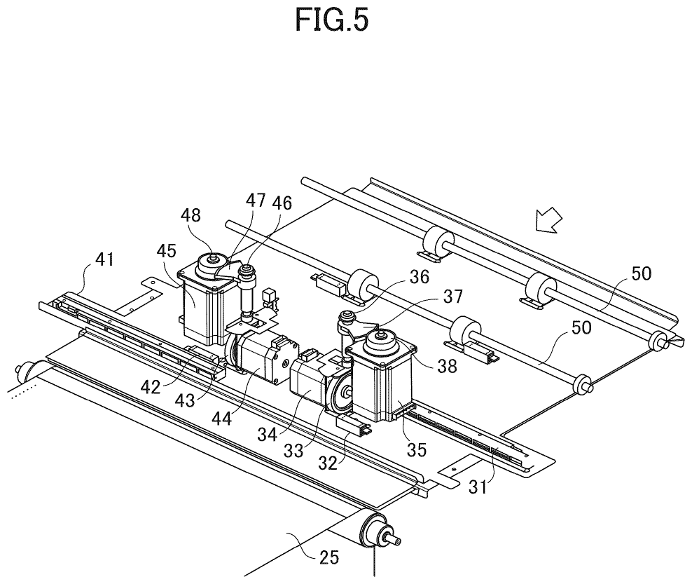

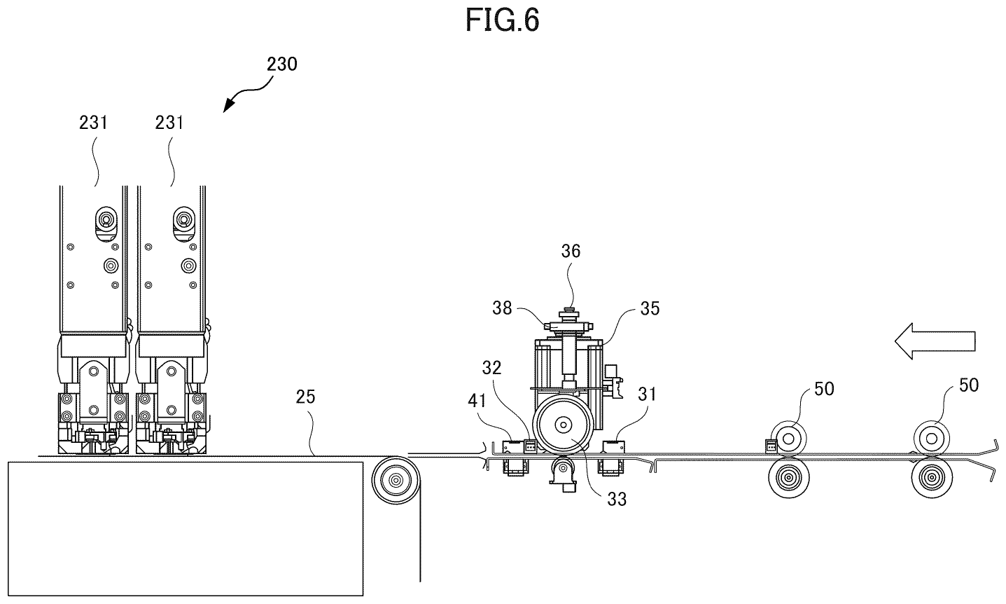

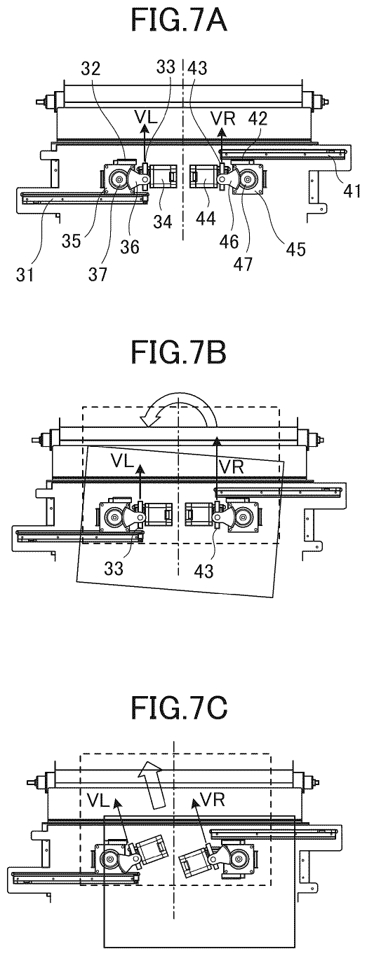

Next, a schematic configuration of a registration unit 210, serving as a pre-image formation registration correcting portion that is an example of a skew feed correcting portion, will be described. FIG. 4 is a plan view illustrating a surrounding configuration including the registration unit 210, FIG. 5 is a perspective view illustrating a surrounding configuration including the registration unit 210, FIG. 6 is a cross-sectional view illustrating a surrounding configuration including the registration unit 210, and FIG. 7 is an operating state diagram of rollers in the registration unit 210.

### Flow of Operation of Registration Unit

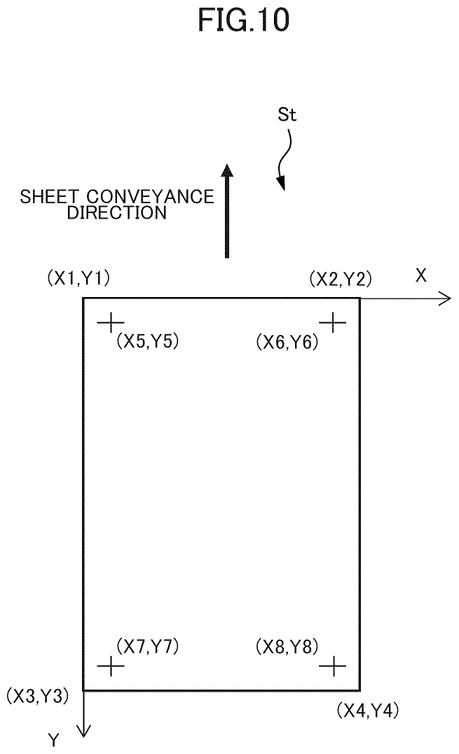

The registration unit 210 includes a left image sensor 31, a right image sensor 41, a left leading registration sensor 32, a right leading registration sensor 42, a left registration roller pair 33, and a right registration roller pair 43. The left and right registration roller pairs 33 and 43 are examples of a pivoting roller pair. The registration unit 210 receives the sheet S from a conveyance roller pair 50 disposed upstream of the left and right registration roller pairs 33 and 43 in the sheet conveyance direction. The conveyance roller pair 50 includes a lower roller constituted by a roller made of ethylene propylene diene terpolymer (EPDM) and an upper roller constituted by a rubber roller made of urethane, and the lower roller is urged toward the upper roller by an urging spring, not shown. The conveyance roller pair 50 is an example of a conveyance unit that conveys the sheet S to the recording unit 230 in the sheet conveyance path. The registration unit 210 corrects the skew and a position of the sheet S in the width direction (a direction X in FIG. 10) perpendicular to the sheet conveyance direction (a direction opposite to a direction Y in FIG. 10).

The registration unit 210 includes a left registration drive motor 34, a right registration drive motor 44, a left steering motor 35, and a right steering motor 45. The left registration roller pair 33 is formed by a rubber roller made of polyurethane, and includes an upper roller, which is rotatably driven by the left registration drive motor 34 to convey the sheet, and a driven roller positioned opposite the upper roller. The right registration roller pair 43 is formed by a rubber roller made of polyurethane, and includes an upper roller, which is rotatably driven by the right registration drive motor 44 to convey the sheet, and a driven roller positioned opposite the upper roller.

The upper roller of the left registration roller pair 33 is pivotably (swingably) supported by a left steering shaft 36, which rotates around a vertical axis as a center, and the left steering shaft 36 is drivingly connected to the left steering motor 35 via a sector gear 37 and a motor gear 38. When the left steering motor 35 is activated, the upper roller of the left registration roller pair 33 swivels around the left steering shaft 36 as a center. Similarly, the upper roller of the right registration roller pair 43 is pivotably supported by a right steering shaft 46, which rotates around a vertical axis as a center, and the right steering shaft 46 is drivingly connected to the right steering motor 45 via a sector gear 47 and a motor gear 48. When the right steering motor 45 is activated, the upper roller of the right registration roller pair 43 swivels around the right steering shaft 46 as a center. With this configuration, the registration unit 210 corrects the skew of the sheet S by conveying the sheet S to rotate using the left and right registration roller pairs 33 and 43.

As illustrated in FIG. 7A, by rotating the left and right registration roller pairs 33 and 43 at the same rotational speed (VL=VR), the sheet S is conveyed straight along the sheet conveyance direction toward the recording unit 230. As illustrated in FIG. 7B, by rotating the left and right registration roller pairs 33 and 43 at different rotational speeds (VL<VR), the sheet S can be rotated, and the skew can be corrected. As illustrated in FIG. 7C, by swiveling the left and right registration roller pairs 33 and 43 at the same angle from the sheet conveyance direction and rotating the left and right registration roller pairs 33 and 43 at the same rotational speed (VL=VR), the sheet S can be conveyed in a diagonal direction without tilting, and a lateral position of the sheet S can be corrected.

### Detection of Inclination Amount

Adjacent to nips of the left and right registration roller pairs 33 and 43, the left and right leading registration sensors 32 and 42 are arranged at the same position in the sheet conveyance direction and different positions in the width direction. As the left and right leading registration sensors 32 and 42, an optical sensor including a light emitting portion that emits light, and a light receiving portion that receives reflected light emitted from the light emitting portion and reflected by the sheet is applied. The control unit 60 calculates an inclination amount of the current sheet S from the timing at which the left and right leading registration sensors 32 and 42 detect the sheet S and the velocity at which the sheet S is conveyed. That is, the left and right leading registration sensors 32 and 42 are examples of a detection unit, and detect the sheet S before the sheet, which is conveyed by the conveyance roller pair 50, has passed through the registration unit 210. In the present embodiment, the left and right leading registration sensors 32 and 42 detect an angle of the leading edge of the sheet S. To be noted, while, in the present embodiment, two sensors, which are the left and right leading registration sensors 32 and 42, are disposed as a leading registration sensor, it is not limited to this, and equal to or more than three sensors may be disposed. Alternatively, if a device measures the inclination amount of the sheet, sensors other than the optical sensor described above, such as an image sensor, may be utilized.

### Detection of Position in Width Direction

The left and right image sensors 31 and 41 are disposed adjacent to the nips of the left and right registration roller pairs 33 and 43. The left image sensor 31 detects a position of a left edge of the sheet S, and the right image sensor 41 detects a position of a right edge of the sheet S. The control unit 60 calculates the position of the sheet S in the width direction based on the positions of the left and right edges of the sheet S. That is, the left and right image sensors 31 and 41 are examples of the detection unit, and detect an angle of a side edge of the sheet S before the sheet S, which is conveyed by the conveyance roller pair 50, has passed through the registration unit 210. To be noted, while, in the present embodiment, the image sensors are disposed to detect each of both the edges of the sheet S, it is not limited to this. For example, it is acceptable to dispose only one image sensor that is longer the width of the sheet S. Alternatively, it is acceptable to detect only one of the side edges and perform control using one of the side edges as a reference.

### Control System

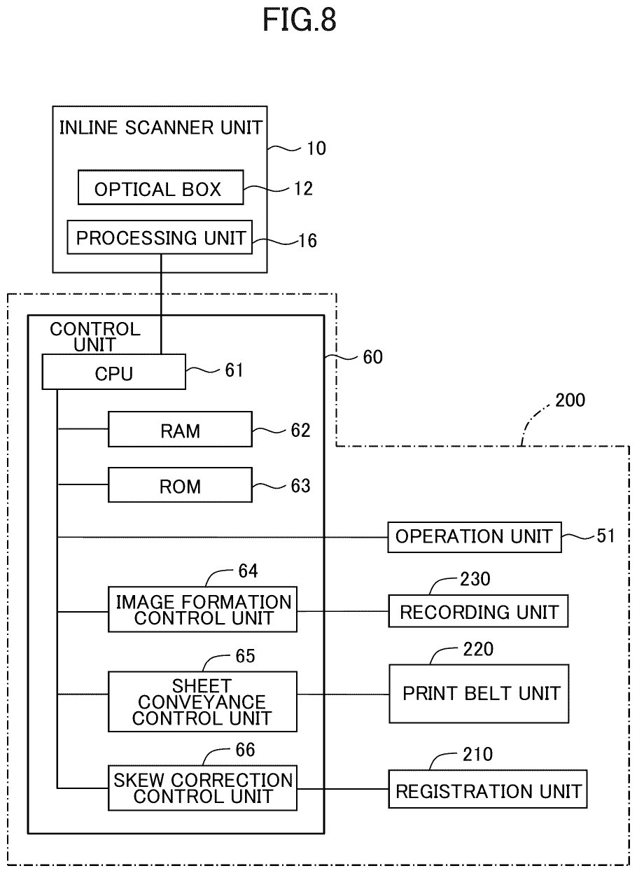

Next, using FIG. 8, the control unit 60 and a control system of the print module 200 will be described. The control unit 60 includes a central processing unit (CPU) 61, a random access memory (RAM) 62, and a read only memory (ROM) 63. By executing predetermined control programs and the like, the CPU 61 implements various processing performed by the print module 200. The RAM 62 and the ROM 63 store various programs and various data in predetermined storage areas. Based on a signal input from an external computer via an interface, not shown, the CPU 61 controls an operation of the registration unit 210 by reading and executing the control programs stored in the ROM 63 while using the RAM 62 as a work memory.

The control unit 60 includes various functional units such as an image formation control unit 64, a sheet conveyance control unit 65, and a skew correction control unit 66. The image formation control unit 64 controls the image formation by transmitting instructions with respect to the recording unit 230. By transmitting signals to driving sources to drive such as the conveyance roller pair 50 and controlling operations of various conveyance rollers, the sheet conveyance control unit 65 controls the conveyance of the sheet S.

The skew correction control unit 66 controls the registration unit 210. In particular, the skew correction control unit 66 obtains detection results input by the left and right image sensors 31 and 41 and the left and right leading registration sensors 32 and 42. By controlling the left and right registration drive motors 34 and 44 and the left and right steering motors 35 and 45 based on the detection results, the skew correction control unit 66 performs the skew correction and the correction of a lateral positional shift of the sheet S. Here, the lateral positional shift (or a lateral registration error) refers to an amount of deviation from a reference point in the width direction which is perpendicular to the sheet conveyance direction.

In addition, the control unit 60 creates a test chart St (refer to FIG. 10) by forming a patch image (an inspection image) on the sheet S using the recording unit 230, and reads the test chart St by using the inline scanner unit 10. At this time, the skew correction control unit 66 obtains a correction value, which is set by reading a sheet shape and a patch position of the test chart St on the print belt 225 using the inline scanner unit 10. Then, by adjusting the skew correction and the lateral positional shift by adding the above correction value, it is possible to correct the front-to-back misalignment due to factors such as the sheet shape. At this time, the accuracy of the image formation position depends on the shape of the sheet S. The skew correction control unit 66 can change a correction reference position for the image formation position of the sheet by offsetting a correction value of the leading edge of the image formation position, a correction value of the lateral edge of the image formation position, and a correction value of skew of the image formation position. With this configuration, even if there are irregularities in the sheet shape, it is possible to adjust the image formation position to a desired position with respect to the sheet S. To be noted, hereinafter, the correction of the image formation position in the sheet conveyance and the width direction are also respectively referred to as leading registration and lateral registration.

As illustrated in FIG. 8, an operation unit 51 is disposed on the print module 200. The operation unit 51 is configured as, for example, a liquid crystal touch panel that includes a display function to display information and an input function for allowing a user to input information, and is disposed on the top of the print module 200. Alternatively, it may display information on a screen on a monitor of a computer connected externally with input operations performed through a mouse or a key board. The operation unit 51 is an example of a receiving unit, and receives mode information regarding a mode selected from a leading registration correction mode and a lateral registration correction mode.

### Inline Scanner Unit

FIG. 9 illustrates the inline scanner unit 10 that reads the sheet on the print belt 225 and the image formed on that sheet at a position downstream of the recording heads 231 in the sheet conveyance direction. The inline scanner unit 10 includes an optical box 12 and a processing unit 16 within a housing 11. The optical box 12 reads the sheet shape and the patch position of the test chart St via a reading glass 13, and transmits the result to the processing unit 16. The processing unit 16 is connected to the control unit 60, processes information obtained by the optical box 12, and transmits the information to the control unit 60. It is possible to apply suitable image sensors, such as, for example, a contact image sensor (CIS) to the optical box 12. The inline scanner unit 10 can be moved in the left and right direction in FIG. 9 by a driving unit, not shown. Then, at a predetermined timing, the inline scanner unit 10 performs a shading process to move a reading position 14 of the optical box 12 from a position of reading the sheet S to a shading position opposite a shading sheet 15.

### Image Processing Process

As illustrated in FIG. 8, the image information read by the optical box 12 is processed by the processing unit 16, and the sheet shape and the patch position of the test chart St are quantified. From these quantified results, correction values for an image position, a sheet position, and image scaling are generated. The generated correction values are transmitted to the control unit 60. The control unit 60 adjusts the image formation position, the sheet position, and the image scaling by applying the correction values to the processing of the registration unit 210, the print belt unit 22, and the recording unit 230.

### Quantification of Sheet Shape and Patch Position

FIG. 10 is a schematic diagram illustrating the test chart St, used to explain a method for quantifying the sheet shape and the patch position. By reading the test chart St using the inline scanner unit 10, as illustrated in FIG. 10, the image is obtained. Coordinates of four corners and four pieces of patches of the test chart St are determined as (X1, Y1) to (X8, Y8) from the obtained image. At this time, the sheet conveyance direction is referred to as the arrow Y direction, and the width direction perpendicular to the sheet conveyance direction is referred to as the arrow X direction.

### Adjustment of Image Formation Position

First, examples of the leading registration and the lateral registration are illustrated. As described above, in a case of saddle stitch binding, it is necessary to adjust the image formation position using the center of the sheet as a reference in the sheet conveyance and width directions. In addition, in a case of case binding, since the sheet is cut using edges as a reference, it is necessary to adjust the image formation position using the edges of the sheet in the sheet conveyance and width directions as a reference.

### Leading Registration Adjustment

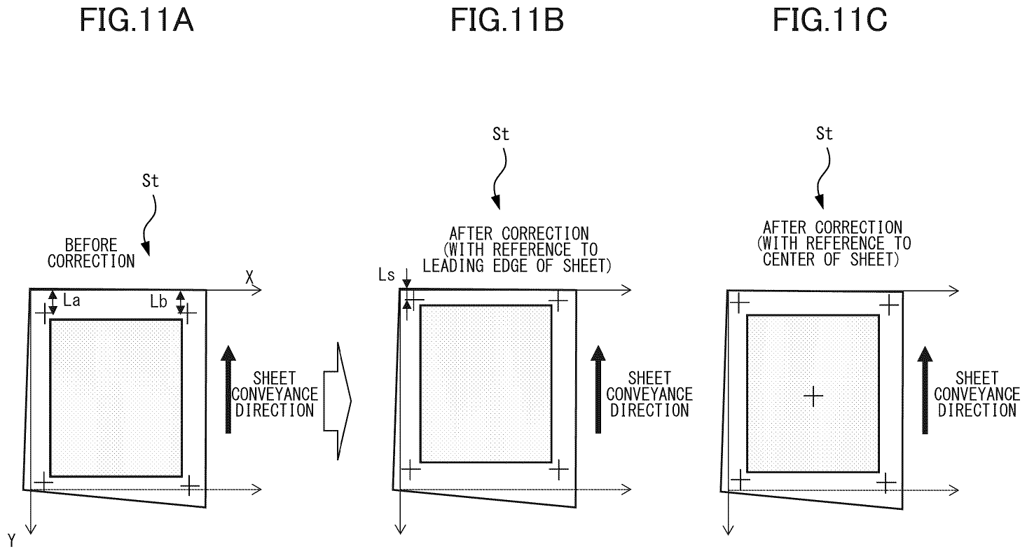

As illustrated in FIG. 11A, by printing the test chart St for the image formation position adjustment and reading the test chart St by the inline scanner unit 10, the coordinates for the four corners and the four pieces of the patches of the test chart St are determined as (X1, Y1) to (X8, Y8). From the coordinates, distances La and Lb from the leading edge of the sheet to the positions of the two pieces of the patches on the leading edge side are determined. As illustrated in FIG. 11B, in a case of aligning the leading registration using the leading edge of the sheet as a reference, when a reference distance from the leading edge of the sheet to the patch positions is referred to as Ls, the leading registration correction value for the image formation position is calculated using Equation 1. This correction yields the results as illustrated in FIG. 11B.

Leading Registration Correction Value=(La+Lb)/2−Ls (Eq. 1)

As illustrated in FIG. 11C, in a case of aligning the leading registration using the center of the sheet as a reference, when, in the arrow Y direction, the coordinate for the center of the sheet is referred to as Y1 and the coordinate for the center of the image is referred to as Y2, the leading registration correction value for the image formation position is calculated using Equation 2. This correction yields the results as illustrated in FIG. 11C.

Leading Registration Correction Value=Y2−Y1 (Eq. 2)

### Lateral Registration

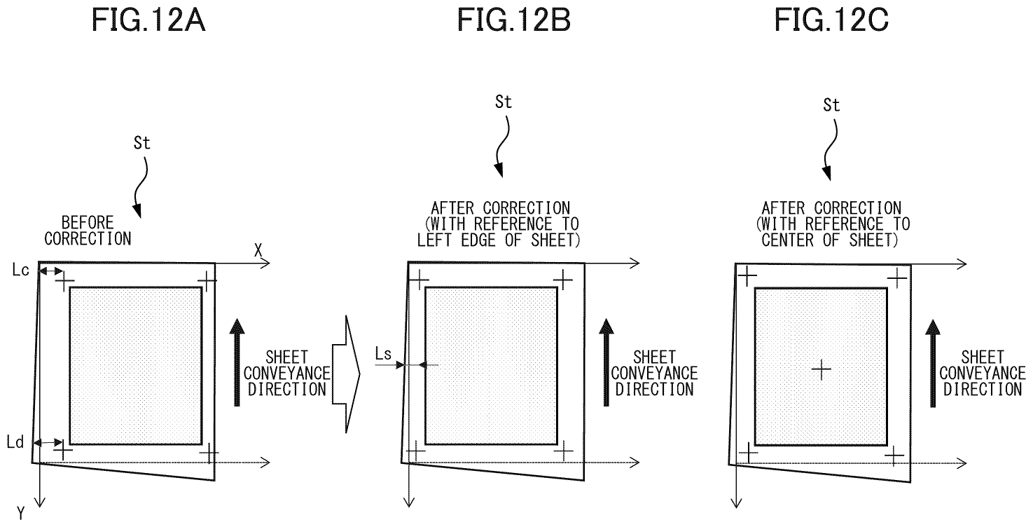

As illustrated in FIG. 12A, by printing the test chart St for the image formation position adjustment and reading the test chart St by the inline scanner unit 10, the coordinates for the positions of the four corners and the four pieces of the patches of the test chart St are determined as (X1, Y1) to (X8, Y8). From the coordinates, distances Lc and Ld from the left edge of the sheet to the positions of two pieces of the patches on the left edge side of the sheet are determined. As illustrated in FIG. 12B, in a case of aligning the lateral registration using the left edge of the sheet as a reference, when a reference distance from the left edge of the sheet to the patch position is referred to as Ls, a lateral registration correction value for the image formation position is calculated using Equation 3. This correction yields the results as illustrated in FIG. 12B.

Lateral Registration Correction Value=(Lc+Ld)/2−Ls (Eq. 3)

As illustrated in FIG. 12C, in a case of aligning the lateral registration using the center of the sheet as a reference, when, in the arrow Y direction, the coordinate for the center of the sheet is referred to as Y1 and the coordinate for the center of the image is referred to as Y2, the lateral registration correction value for the image formation position is calculated using Equation 4. This correction yields the results as illustrated in FIG. 12C.

Lateral Registration Correction Value=Y2−Y1 (Eq. 4)

As described above, by changing the correction reference, it is possible to change the image formation position for printing on the sheet in the sheet conveyance and width directions depending on such as a method of the post processing. Here, in image forming apparatuses that handle cut sheets, there are apparatuses that provide high precision print position stability by adjusting the posture and position of the sheet (registration). However, since, ordinally, the registration is performed using one of edges of a rectangular sheet as a reference, variations in the accuracy of print position on each sheet depend on the cutting accuracy and the deformation of the sheet. In addition to edge lengths, elements of sheet geometry also include the perpendicularity and parallelism between the edges, and the cutting accuracy and the deformation of the sheet, which significantly affect these aspects, can vary greatly due to differences in cutting lots and environmental conditions. The accuracy of the print position is influenced by the sheet shape. Therefore, to achieve the image formation with the accuracy of the print position equivalent to offset printing using cut sheet printing machines, the task of adjusting the print position deviation is required each time a change in the sheet cutting lot or a setup environment occurs.

For example, since, in the post processing steps such as the cutting, aligning the cut positions using the sheet conveyance direction as a reference is frequently practiced, it is desirable to align the image formation position using the leading edge of the sheet as a reference. In addition, for deliverables without involving the post processing, especially for large sizes, it is desirable to adjust the image formation position using a long edge of the sheet as a reference (for example, when conveying A3 size sheet in a longitudinal direction, use the left edge of the sheet as a reference). Therefore, in addition to a technique of switching the image formation position in the sheet conveyance direction in which the printing is performed on the sheet, also in the width direction and skew components, it is necessary to adjust the image formation position by switching the reference. Also, in addition to a technique of switching the image formation position in the width direction in which the printing is performed on the sheet, also in the sheet conveyance direction and skew components, it is necessary to adjust the image formation position by switching the reference. Therefore, in the present embodiment, depending on whether the post processing step is anticipated or a long sheet without involving the post processing is anticipated, it is possible to change the reference positions for the correction of the image formation position in the leading registration, the lateral registration, and the skew correction. In addition, the correction of the image formation position is performed by detecting an overall shape of the sheet through reading the sheet shape and the patches of the test chart St using the inline scanner unit 10. At that time, freely choosing the reference position for the correction of the image formation position is enabled.

### Skew Correction

Next, the skew correction for the image formation position adjustment will be described. As described above, it is desirable to consider the cutting errors of the sheet not only in the sheet conveyance and width directions but also in the skew components. Due to the errors in the skew components of the sheet, the image formation position with respect the sheet varies depending on whether it is aligned using leading edge of the sheet as a reference or the left edge of the sheet as a reference. In the post processing such as the cutting, since alignment is often performed using the sheet conveyance direction as a reference, it is preferable to align the image formation position using the leading edge of the sheet as a reference. In addition, for deliverables without involving the post processing, especially in the case of the large size, it is desirable to align the image formation position using the long edge of the sheet as a reference (for example, in a case of conveying the A3 size in the longitudinal direction, use the left edge the sheet as a reference).

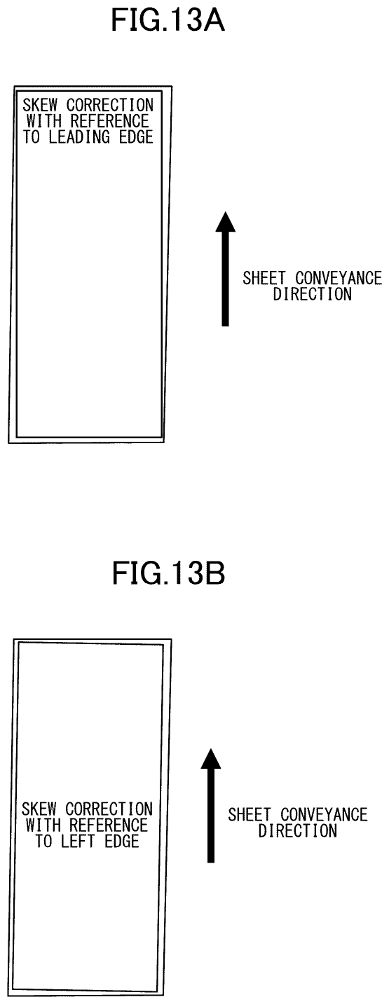

Here, FIGS. 13A and 13B show the image formation position in assuming a case of the long sheet (large size) without involving the post processing. When the image formation position with respect to the sheet is aligned using the leading edge of the sheet as a reference, margins at a leading edge portion of the left edge and a trailing edge portion of the right edge of the sheet become excessively small as illustrated in FIG. 13A, and it is not preferred. On the other hand, as illustrated in FIG. 13B, when aligning the image formation position using the left edge of the sheet as a reference, overall spacing looks even, and it is preferred to the example of FIG. 13A.

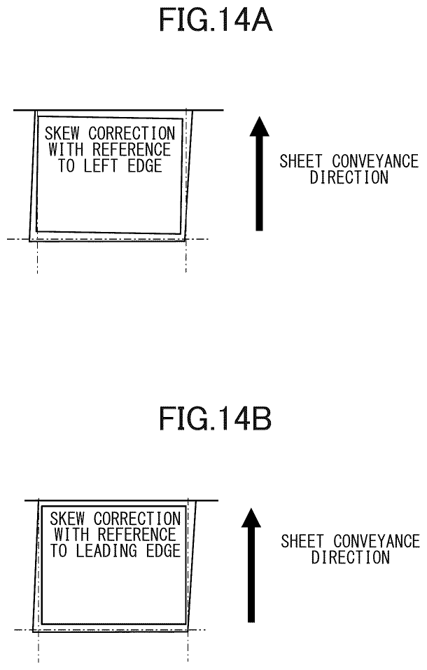

Next, FIGS. 14A and 14B show the image formation position in assuming a case of cutting three sides: the trailing edge, the left edge, and the right edge of the sheet. When the image formation position is aligned using the left edge of the sheet as a reference as illustrated in FIG. 14A, the margins after the cutting become uneven with respect to cutting positions indicated by dot dash lines, and it is not preferred. On the other hand, as illustrated in FIG. 14B, when aligning the image formation position using the leading edge of the sheet as a reference, the margins after the cutting become even with respect to the cutting positions indicated by the dot dash lines, and it is preferred to the example of FIG. 14A. On the other hand, in a case where, as illustrated in FIG. 14A, the image formation position is aligned using the left edge of the sheet as a reference, with respect to a technique of switching the image formation position in the sheet conveyance direction in which the image is printed on the sheet, it is desirable to switch a reference used for the image formation position also in the skew components.

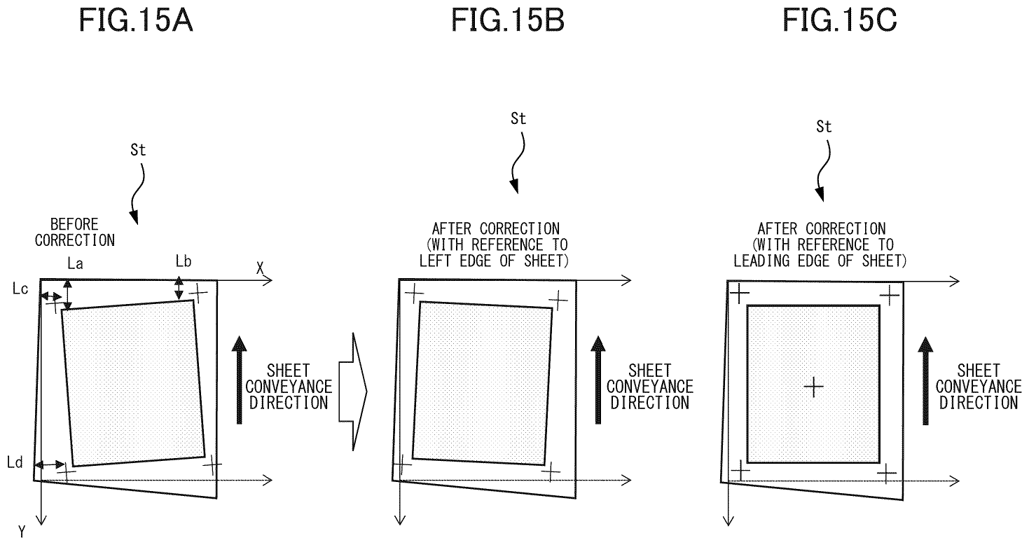

Hereinafter, using FIGS. 15A to 15C, a method for calculating the skew correction value will be described. As illustrated in FIG. 15A, by creating the test chart St for the adjustment of the image formation position and reading the test chart St by the inline scanner unit 10, the coordinates for the four corners and the four pieces of the patches of the test chart St are determined as (X1, Y1) to (X8, Y8). From the coordinates, the distances La and Lb from the leading edge of the sheet to the positions of the two pieces of the patches on the leading edge side of the sheet and the distances Lc and Ld from the left edge of the sheet to the positions of the two pieces of the patches on the left edge side of the sheet are determined.

As illustrated in FIG. 15B, when the skew is aligned using the left edge of the sheet as a reference, the skew correction value for the image formation position is calculated by Equation 5.

Skew Correction Value=Lc−Ld (Eq. 5)

As illustrated in FIG. 15C, when aligning by using the leading edge of the sheet as a reference, the skew correction value for the image formation position is calculated by Equation 6.

Skew Correction Value=La−Lb (Eq. 6)

By the correction described above, correction results as illustrated in FIGS. 15B and 15C are obtained. By correcting the leading registration value, the lateral registration value, and the skew value, which are input with respect to the registration unit 210 and the recording unit 230, using the leading registration correction value, the lateral registration correction value, and the skew correction value obtained from Equations 1 to 6, it is possible to change the image formation position with respect to the sheet S.

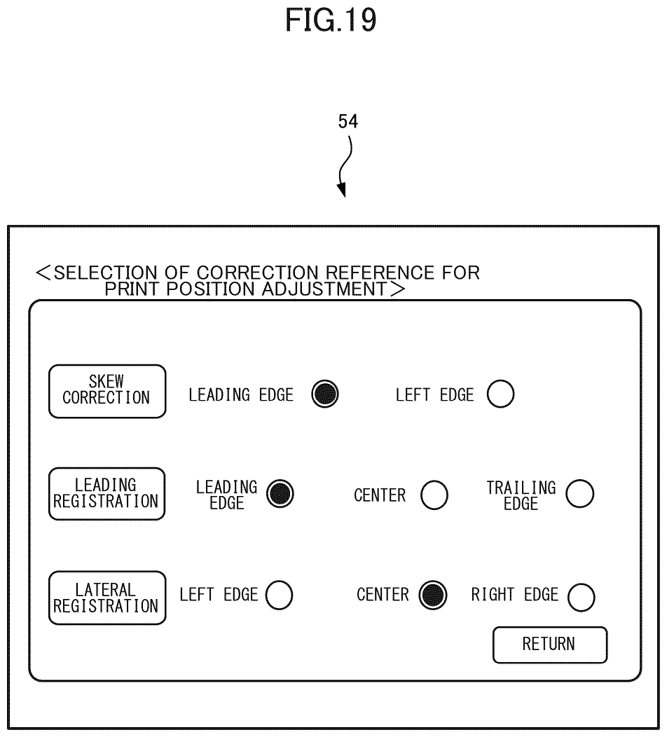

In the present embodiment, the control unit 60 can switch between a leading registration correction mode and a lateral registration correction mode with respect to the skew correction. That is, the control unit 60 is configured to selectively execute the leading registration correction mode and the lateral registration correction mode by switching between the leading registration correction mode and the lateral registration correction mode. The leading registration correction mode is an example of a first mode. In the leading registration correction mode, based on the skew of the leading edge of the sheet and the position of the sheet in the width direction, which are detected by the sensors, the skew of the sheet is corrected to align the leading edge of the sheet with the width direction, and the position of the sheet in the width direction is corrected such that the position of the sheet in the width direction is aligned using a first width direction position of the sheet as a reference, using a second with direction position, which is different from the first width direction position, as a reference, or a third width direction position, which is different from the first and second width direction positions, as a reference. The first, second, and third width direction positions will be described in detail using FIG. 19. In addition, in the leading registration correction mode, with respect to the corrected sheet, the control unit 60 sets the image formation position at which the image is formed, and forms the image.

In addition, the lateral registration correction mode is an example of a second mode. In the lateral registration correction mode, based on the skew of the left edge of the sheet and the position of the sheet in the width direction, which are detected by the sensors, the skew of the sheet is corrected to align the side edge of the sheet with the sheet conveyance direction, and the position of the sheet in the width direction is corrected to be aligned using the first width direction position of the sheet as a reference, using the second with direction position as a reference, or the third width direction position as a reference. In addition, in the lateral registration correction mode, with respect to the corrected sheet, the control unit 60 sets the image formation position at which the image is formed, and forms the image.

In addition, with respect to the sheet whose skew and position in the width direction are corrected in the leading and lateral registration correction modes, the control unit 60 corrects the image formation position in the sheet conveyance direction with respect to the sheet using a first sheet conveyance direction position as a reference, a second sheet conveyance direction position, which is different from the first sheet conveyance direction position, as a reference, or a third sheet conveyance direction position, which is different from the first and second sheet conveyance direction positions, as a reference. Then, with respect to the corrected sheet, the control unit 60 sets the image formation position at which the image is formed, and forms the image.

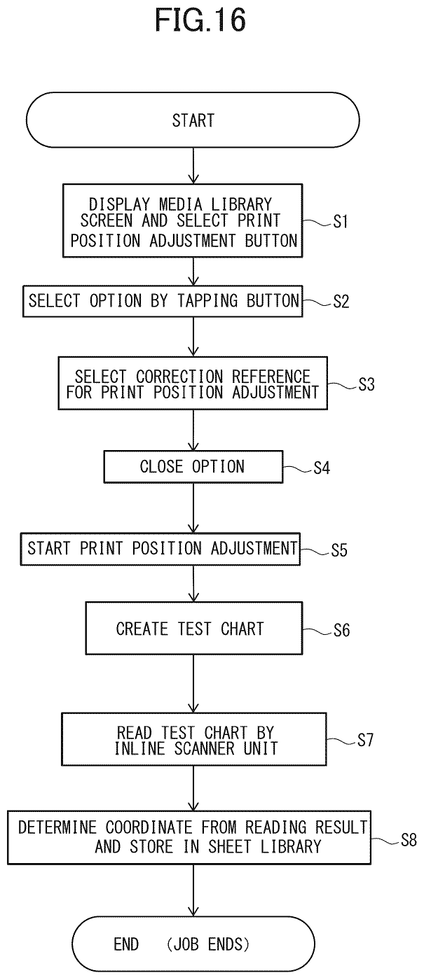

Next, a processing procedure for adjusting the image formation position by changing the correction references will be described with reference to a flowchart illustrated in FIG. 16. It is preferable to perform the adjustment prior to executing an image formation job to prevent a change in sheet conditions. Here, the adjustments are performed with respect to utilized media in each image formation job.

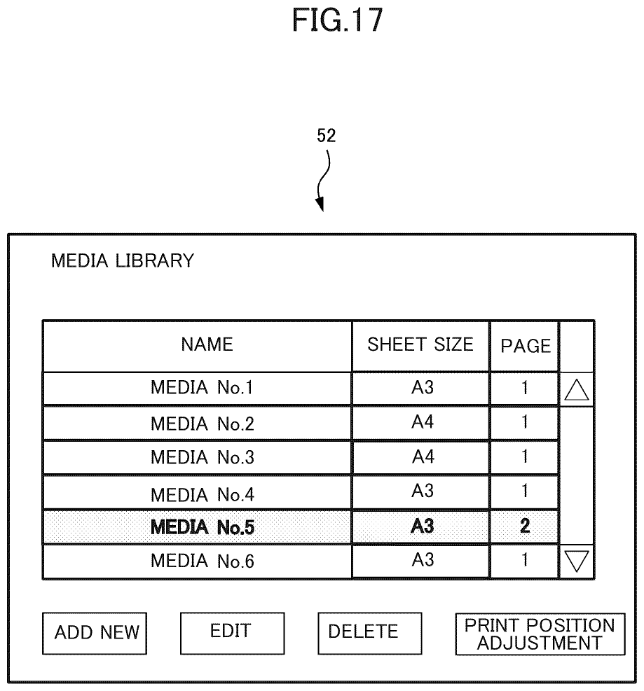

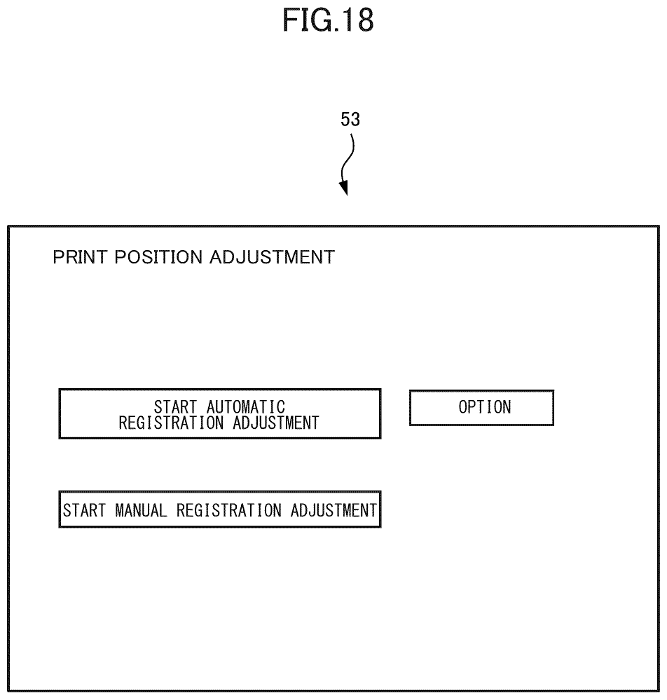

As illustrated in FIG. 17, the control unit 60 displays a media library screen 52 on the operation unit 51. The user specifies the media on the media library screen 52, and selects by tapping a print position adjustment button (STEP S1). As illustrated in FIG. 18, the control unit 60 displays a print position adjustment screen 53 on the operation unit 51. There are an automatic registration adjustment button and a manual registration adjustment button on the print position adjustment screen 53, and an option button is disposed adjacent to the automatic registration adjustment button. The user performs selection by tapping the option button (STEP S2).

As illustrated in FIG. 19. the control unit 60 displays a correction reference selection screen 54 for the image formation position adjustment on the operation unit 51. On the correction reference selection screen 54, the selectable correction references for the skew correction, the leading registration correction, and the lateral registration correction are displayed, and the user selects the correction reference for each correction (STEP S3). That is, the operation unit 51 receives mode information regarding the mode selected between the leading and lateral registration correction modes.

Regarding the leading registration correction, the operation unit 51 receives one selected piece among first information (leading edge, center, trailing edge) regarding the correction reference for the image formation position in the sheet conveyance direction. When executing the leading registration correction mode, the control unit 60 sets the image formation position in the sheet conveyance direction based on the first information. The center in the first information is, for example, the reference position, and denotes the central position of the sheet in the sheet conveyance direction. To be noted, here, the central position refers to a default setting position for binding margins or the initial setup position when no particular specifications are provided. The leading edge in the first information is an example of a downstream edge position further downstream than the center. The trailing edge in the first information is an example of an upstream edge position further upstream than the center. In addition, the leading edge corresponds to the first conveyance direction position, and is the image formation position in the sheet conveyance direction using the leading edge of the sheet as a reference. The center corresponds to the second conveyance direction position, and is the image formation position in the sheet conveyance direction using the center of the sheet as a reference. The trailing edge corresponds to the third conveyance direction position, and is the image formation position in the sheet conveyance direction using the trailing edge of the sheet as a reference. To be noted, while, in the present embodiment, the first information includes three elements: the leading edge, the center, and the trailing edge, it is not limited to this, and, for example, the first information may include two elements such as the leading edge and the center.

Regarding the lateral registration correction, the operation unit 51 receives one selected piece among second information (left edge, center, right edge) regarding the correction reference for the image formation position in the width direction. When executing the lateral registration correction mode, the control unit 60 sets the image formation position in the width direction based on the second information. The center in the second information is, for example, the reference position, and denotes the central position of the sheet in the width direction. To be noted, here, the central position also refers to the default setting position for the binding margins or the initial setup position when no particular specifications are provided. The left edge in the second information is an example of an edge position on one side in the width direction from the center. The right edge in the second information is an example of an edge position on the other side in the width direction from the center. In addition, the left edge corresponds to the first width direction position, and, in the width direction, is a position at which the edge of the sheet on the one side aligns with the edge of the sheet conveyance path on the one side. The center corresponds to the second width direction position, and, in the width direction, is a position at which the center of the sheet aligns with the center of the sheet conveyance path. The right edge corresponds to the third width direction position, and, in the width direction, is a position at which the edge of the sheet on the other side aligns with the edge of the sheet conveyance path on the other side. To be noted, while, in the present embodiment, the second information includes three elements: the left edge, center, and right edge, it is not limited to this, and, for example, the second information may include two elements such as the left edge and center.

After selecting the correction references, the user closes the option by tapping a return button, and returns to the print position adjustment screen 53 illustrated in FIG. 18 (STEP S4). By tapping an automatic registration start button on the print position adjustment screen 53, the control unit 60 starts the print position adjustment (STEP S5). The control unit 60 creates the test chart St by forming the patch images on the sheet (STEP S6). The control unit 60 reads the four corners and the four pieces of the patches of the test chart St using the inline scanner unit 10 (STEP S7).

From the detection results of the inline scanner unit 10, the control unit 60 determines the coordinates for the four corners and the four pieces of the patches of the test chart St as (X1, Y1) to (X8, Y8). Based on the coordinates, the control unit 60 determines the distances La and Lb from the leading edge of the sheet to the positions of the two pieces of the patches on the leading edge side of the sheet and distances Lc and Ld from the left edge of the sheet to the positions of the two pieces of the patches on the left edge side of the sheet, calculates each correction value, and stores the correction values in the sheet library (STEP S8). Thereafter, based on the mode information input by the user, the control unit 60 executes one of the leading or lateral registration correction mode.

That is, before executing the leading or lateral registration correction mode, the control unit 60 creates the test chart St by forming the patch images on the sheet using the recording unit 230 without executing leading and lateral registration correction and correcting the skew by the registration unit 210. Then, the control unit 60 reads the leading and trailing edges and the patch images of the test chart St by the inline scanner unit 10. When executing the leading registration correction mode, the control unit 60 sets the image formation position based on positional relationships among the leading and side edges of the sheet and the patch images, which are read by the inline scanner unit 10, and an angle of the leading edge of the sheet which the registration unit 210 corrects. When executing the lateral registration correction mode, the control unit 60 sets the image formation position based on positional relationships among the leading, side edges of the sheet and the patch images, which are read by the inline scanner unit 10, and the angle of the leading edge of the sheet which the registration unit 210 corrects.

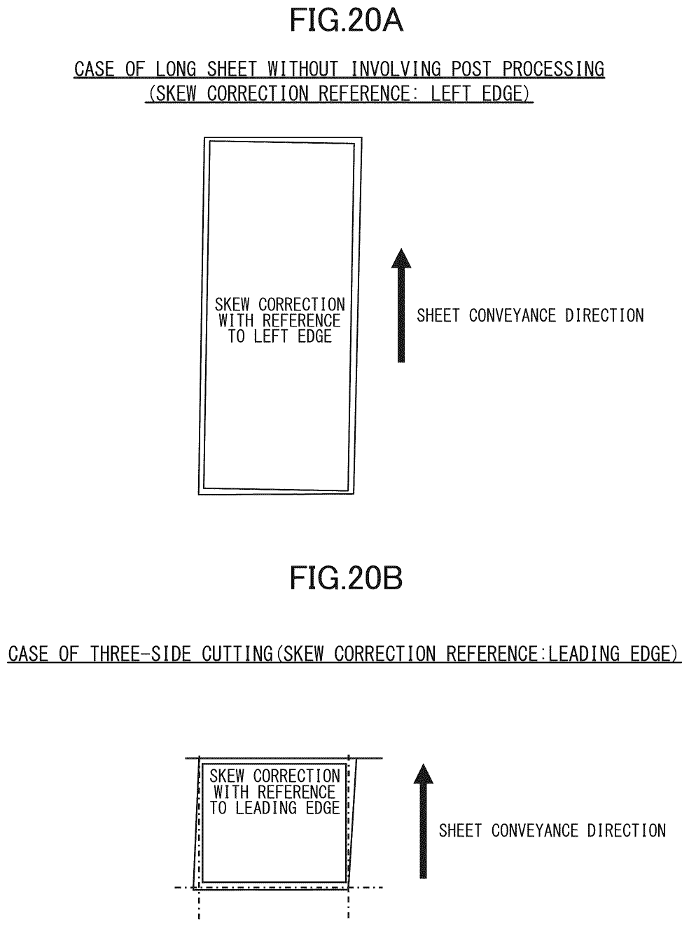

As illustrated in FIG. 20, by changing the correction references as described above to change the image formation position in the sheet conveyance direction, in which the sheet is printed, depending on the presence or absence of the post processing such as the cutting, it is possible to perform the print position adjustment with respect to the sheet satisfactorily. That is, since, as illustrated in FIG. 20A, by aligning the skew using the left edge of the sheet as a reference, the margins at the trailing edge of sheet also looks even, and it is preferred to the example of FIG. 13A. In addition, since, as illustrated in FIG. 20B, by aligning the skew using the leading edge of the sheet as a reference, the margins after the cutting become even with respect to the cutting positions indicated by the dot dash lines, and it is preferred to the example of FIG. 14A.

As described above, according to the print module 200 of the present embodiment, it is possible to perform the leading and lateral registration correction modes by switching between the modes. Therefore, it is possible to suppress the errors in the skew components of the sheet, and, even in a case where the skew occurs in the sheet, it is possible to improve the accuracy of the image formation position. Thereby, for example, by changing the image formation position in the sheet conveyance direction, in which the sheet is printed, depending on the case of the presence or absence of the post processing such as the cutting, it is possible to perform the print position adjustment with respect to the sheet satisfactorily in either case.

According to this disclosure, it is possible to improve the accuracy of the image formation position even in a case where the skew occurs in the sheet.

### Other Embodiments

To be noted, while, in the embodiment described above, the skew correction is performed by changing the posture of the sheet through reflecting the correction values on the registration unit 210, it is not limited to this. That is, in the embodiment described above, assuming that the leading edge or side edge of the sheet arrives straight, the mode is switched between the leading and lateral registration correction modes to adjust the image only in the arrow X or Y direction. On the contrary, it is acceptable to adjust the image in both the arrow X and Y directions while rotating the image according to inclinations of the leading and side edges of the sheet detected by a sensor. That is, without performing the skew correction with respect to the sheet, it is acceptable to apply a method that adjusts the image formation position, including the skew components, when forming the image on the sheet by the recording unit 230. In this case, the control unit 60 is enabled to execute a third mode in which the image formation position is changed using the leading edge of the sheet as a reference based on the angle of the leading edge of the sheet, and a fourth mode in which the image formation position is changed using the side edge of the sheet as a reference based on the angle of the side edge of the sheet. Also, the control unit 60 may selectively execute the first mode, the second mode, the third mode, and the fourth mode.

In addition, while, in the embodiments described above, the image forming system is applied to the inkjet recording system 1 using the inkjet recording method, it is not limited to this, and may also be applied to an image forming apparatus of an electrophotographic system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-003561, filed Jan. 12, 2024, which is hereby incorporated by reference herein in its entirety.

What is claimed is:

1. An image forming apparatus comprising:
an image forming unit configured to form an image on a sheet;
a conveyance unit configured to convey the sheet in a conveyance path;
a skew feed correcting portion configured to correct skew of the sheet conveyed by the conveyance unit and a position of the sheet in a width direction perpendicular to a sheet conveyance direction;
a detection unit configured to detect the sheet before the sheet conveyed by the conveyance unit has passed through the skew feed correcting portion; and
a control unit configured to control the skew feed correcting portion and the image forming unit,
wherein the control unit is configured to selectively execute a first mode and a second mode by switching between the first mode and the second mode,
wherein, in the first mode, based on skew of a leading edge of the sheet and the position of the sheet in the width direction which are detected by the detection unit,
the control unit is configured to
correct the skew of the sheet to align the leading edge of the sheet with the width direction,
correct the position of the sheet in the width direction using a first width direction position as a reference, using a second width direction position as a reference which is different from the first width direction position in the width direction, or using a third width direction position as a reference which is different from the first width direction position and the second width direction position in the width direction, and
set an image formation position for forming the image with respect to the sheet which has been corrected, and
wherein, in the second mode, based on skew of a side edge of the sheet and the position of the sheet in the width direction which are detected by the detection unit,
the control unit is configured to
correct the skew of the sheet to align the side edge of the sheet with the sheet conveyance direction,
correct the position of the sheet in the width direction using the first width direction position as the reference, using the second width direction position as the reference, or using the third width direction position as the reference, and
set the image formation position with respect to the sheet which has been corrected.

2. An image forming apparatus comprising:
an image forming unit configured to form an image on a sheet;
a conveyance unit configured to convey the sheet in a conveyance path;
a skew feed correcting portion configured to correct skew of the sheet conveyed by the conveyance unit and a position of the sheet in a width direction perpendicular to a sheet conveyance direction;
a detection unit configured to detect the sheet before the sheet conveyed by the conveyance unit has passed through the skew feed correcting portion; and
a control unit configured to control the skew feed correcting portion and the image forming unit,
wherein the control unit is configured to selectively execute a first mode and a second mode by switching between the first mode and the second mode,
wherein, in the first mode, based on the skew of a leading edge of the sheet and the position of the sheet in the width direction which are detected by the detection unit,
the control unit is configured to
correct the skew of the sheet to align the leading edge of the sheet with the width direction,
correct the position of the sheet in the width direction using a first width direction position as a reference or using a second width direction position as a reference which is different from the first width direction position, and
set an image formation position for forming the image with respect to the sheet which has been corrected, and
wherein, in the second mode, based on skew of a side edge of the sheet and the position of the sheet in the width direction which are detected by the detection unit,
the control unit is configured to
correct the skew of the sheet to align the side edge of the sheet with the sheet conveyance direction,
correct the position of the sheet in the width direction using the first width direction position as the reference or using the second width direction position as the reference, and
set the image formation position with respect to the sheet which has been corrected.

3. The image forming apparatus according to claim 1,
wherein the first width direction position is a position at which an edge on one side of the sheet aligns with an edge on the one side of the conveyance path in the width direction,
wherein the second width direction position is a position at which a center of the sheet aligns with a center of the conveyance path in the width direction, and
wherein the third width direction position is a position at which an edge on the other side of the sheet aligns with an edge on the other side of the conveyance path in the width direction.

4. The image forming apparatus according to claim 1, wherein, with respect to the sheet whose skew and position in the width direction have been corrected in the first mode or the second mode,
the control unit is configured to
correct an image formation position in the sheet conveyance direction with respect to the sheet using a first conveyance direction position as a reference or using a second conveyance direction position as a reference which is different from the first conveyance direction position in the sheet conveyance direction, and
set the image formation position with respect to the sheet.

5. The image forming apparatus according to claim 1, wherein, with respect to the sheet whose skew and position in the width direction have been corrected in the first mode or the second mode,
the control unit is configured to
correct an image formation position in the sheet conveyance direction with respect to the sheet using a first conveyance direction position as a reference, using a second conveyance direction position as a reference which is different from the first conveyance direction position in the sheet conveyance direction, or using a third conveyance direction position as a reference which is different from the first conveyance direction position and the second conveyance direction position in the sheet conveyance direction, and
set the image formation position with respect to the sheet.

6. The image forming apparatus according to claim 5,
wherein the first conveyance direction position is a position based on the leading edge of the sheet in the sheet conveyance direction,
wherein the second conveyance direction position is a position based on a center of the sheet in the sheet conveyance direction, and
wherein the third conveyance direction position is a position based on a trailing edge of the sheet in the sheet conveyance direction.

7. The image forming apparatus according to claim 1,
further comprising a receiving unit configured to receive mode information related to a mode selected between the first mode and the second mode,
wherein the control unit is configured to execute one of the first mode and the second mode based on the mode information.

8. The image forming apparatus according to claim 5,
further comprising a receiving unit configured to receive mode information related to a mode selected between the first mode and the second mode,
wherein the receiving unit is configured to receive first information related to a conveyance direction position selected among the first conveyance direction position, the second conveyance direction position, and the third conveyance direction position,
wherein the control unit is configured to execute one of the first mode and the second mode based on the mode information, and set the image formation position in the sheet conveyance direction with respect to the sheet based on the first information which has been received.

9. The image forming apparatus according to claim 7,
wherein the receiving unit is configured to receive second information related to a width direction position selected among the first width direction position, the second width direction position, and the third width direction position, and
wherein the control unit is configured to set the image formation position in the width direction with respect to the sheet based on the second information which has been received.

10. The image forming apparatus according to claim 1,
further comprising a reading unit configured to read the leading edge and the side edge of the sheet and the image formed on the sheet at a location further downstream than the image forming unit in the sheet conveyance direction,
wherein, before executing the first mode or the second mode, the control unit is configured to form an inspection image on the sheet using the image forming unit without correcting the skew and the position of the sheet by the skew feed correcting portion, and read the leading edge and the side edge of the sheet and the inspection image using the reading unit,
wherein, in the first mode, the control unit is configured to set the image formation position based on positional relationships among the leading edge and the side edge of the sheet and the inspection image read by the reading unit, and an angle of the leading edge of the sheet which the skew feed correcting portion corrects, and
wherein, in the second mode, the control unit is configured to set the image formation position based on the positional relationships among the leading edge and the side edge of the sheet and the inspection image read by the reading unit, and an angle of the side edge of the sheet which the skew feed correcting portion corrects.

11. The image forming apparatus according to claim 1,
wherein the skew feed correcting portion includes a pivoting roller pair configured to convey the sheet, and
wherein the skew feed correcting portion is configured to correct the skew of the sheet by conveying the sheet in a pivoting manner using the pivoting roller pair.

12. The image forming apparatus according to claim 1, further comprising a sheet processing unit configured to perform processing on the sheet on which the image has been formed by the image forming unit.
